(19) United States
(12) Patent Application Publication
(10) Pub. No.: US 2026/0019017 A1
(43) Pub. Date: Jan. 15, 2026

(54) CONTROLLER CIRCUIT FOR MOTOR

(71) Applicant: ROHM CO., LTD., Kyoto-shi (JP)

(72) Inventor: Tatsuro SHIMIZU, Kyoto-shi (JP)

(21) Appl. No.: 19/336,764

(22) Filed: Sep. 23, 2025

Related U.S. Application Data
(63) Continuation of application No. PCT/JP2024/010831, filed on Mar. 19, 2024.

(30) Foreign Application Priority Data
Mar. 31, 2023 (JP) 2023-058521

(51) Int. Cl. H02P 23/00; H02P 23/16

(52) U.S. Cl. CPC H02P 23/0077; H02P 23/16; H02P 2205/01; H02P 2205/07; H02P 2207/05

(57) ABSTRACT

A controller circuit includes a major controller and a minor controller. The major controller controls a major loop in which a rotational speed of a motor serves as a controlled variable. The minor controller controls a minor loop in which a current flowing through the motor serves as a controlled variable. A sixth coefficient that defines a bandwidth of the minor controller is determined relative to a third coefficient that defines a bandwidth of the major controller.

### CROSS REFERENCE TO RELATED APPLICATIONS

This application is a continuation under 35 U.S.C. § 120 of PCT/JP2024/010831, filed Mar. 19, 2024, which is incorporated herein by reference, and which claimed priority to Japanese Application No. 2023-058521, filed Mar. 31, 2023. The present application likewise claims priority under 35 U.S.C. § 119 to Japanese Application No. 2023-058521, filed Mar. 31, 2023, the entire content of which is also incorporated herein by reference.

### BACKGROUND

### 1. Technical Field

The present disclosure relates to a controller circuit for motor.

### 2. Description of the Related Art

Feedback control utilizing a PI (proportional-integral) compensator is widely employed in motor control. Various methods for setting the coefficients of such compensators have been proposed, including one known as the pole-zero cancellation method. A closed-loop control system designed with the pole-zero cancellation method has a transfer function H(s) between input and output that is equivalent to a first-order step response and is expressed by the following equation:

H(s)=1/(1+sT)

In some cases, a multi-loop control system is employed as a method for controlling a motor. The multi-loop control system includes a major loop (also referred to as an outer loop) and a minor loop (also referred to as an inner loop). For example, in the major loop, feedback control (frequency control) is performed to generate a current command value such that a rotational speed of the motor coincides with a target value. In the minor loop, feedback control (current control) is performed to generate a voltage command value to be applied to a coil, such that a coil current of the motor approaches the current command value.

### BRIEF DESCRIPTION OF THE DRAWINGS

Embodiments will now be described, by way of example only, with reference to the accompanying drawings which are meant to be exemplary, not limiting, and wherein like elements are numbered alike in several Figures, in which:

FIG. 1 is a block diagram illustrating a general PI compensator used in motor control;

FIG. 2 is a block diagram illustrating a motor drive system including a controller circuit according to an embodiment;

FIG. 3 is a diagram illustrating automatic tuning of a first coefficient K1 of a first PI compensator shown in FIG. 2;

FIG. 4 is a diagram illustrating tuning of a third coefficient K3 of the first PI compensator shown in FIG. 2;

FIG. 5 is a block diagram illustrating a conventional PI compensator;

FIG. 6 is a block diagram illustrating an example configuration of the first PI compensator; and

FIG. 7 is a block diagram illustrating an example configuration of the second PI compensator.

### DETAILED DESCRIPTION

### Outline of Embodiments

An outline of several example embodiments of the disclosure follows. This outline is provided for the convenience of the reader to provide a basic understanding of such embodiments and does not wholly define the breadth of the disclosure. This outline is not an extensive overview of all contemplated embodiments and is intended to neither identify key or critical elements of all embodiments nor to delineate the scope of any or all aspects. Its sole purpose is to present some concepts of one or more embodiments in a simplified form as a prelude to the more detailed description that is presented later. For convenience, the term “one embodiment” may be used herein to refer to a single embodiment or multiple embodiments of the disclosure.

A controller circuit for a motor according to one embodiment comprises: a major controller configured to control a rotational speed of the motor as a controlled variable; and a minor controller provided inside the major controller and configured to control a current flowing through the motor as a controlled variable. The major controller includes: a first Proportional-Integral (PI) compensator configured to generate a manipulated variable based on an error between a detected value of the controlled variable of the motor and a command value of the controlled variable; and a first auto-tuning circuit configured to optimize parameters of the first PI compensator. The first PI compensator includes: a first integrator configured to integrate the error; a first gain circuit configured to multiply an output of the first integrator by a first coefficient; a first adder configured to add the output of the first gain circuit and the error; a second gain circuit configured to multiply an output of the first adder by a second coefficient, the second coefficient being an inverse of the first coefficient; and a third gain circuit configured to multiply an output of the second gain circuit by a third coefficient. The first auto-tuning circuit is configured to vary the first coefficient and to adjust the first coefficient to a value at which a phase difference between the error and the controlled variable becomes 90 degrees. The minor controller includes: a second PI (Proportional-Integral) compensator configured to generate a manipulated variable based on an error between a detected value of the current of the motor and a current command value output from the first PI compensator; and a second auto-tuning circuit configured to optimize parameters of the second PI compensator. The second PI compensator includes: a second integrator configured to integrate the error; a fourth gain circuit configured to multiply an output of the second integrator by a fourth coefficient; a second adder configured to add the output of the fourth gain circuit and the error; a fifth gain circuit configured to multiply an output of the second adder by a fifth coefficient, the fifth coefficient being an inverse of the fourth coefficient; and a sixth gain circuit configured to multiply an output of the fifth gain circuit by a sixth coefficient. The second auto-tuning circuit is configured to vary the fourth coefficient and to adjust the fourth coefficient to a value at which a phase difference between the error and the controlled variable becomes 90 degrees. The sixth coefficient is determined relative to the third coefficient as a reference.

In this configuration, the third coefficient does not affect a phase characteristic. Therefore, in the major loop, the phase difference can be optimized by varying the first coefficient, thereby facilitating automatic tuning. Similarly, the sixth coefficient does not affect a phase characteristic. Therefore, in the minor loop, the phase difference can be optimized by varying the fourth coefficient, thereby facilitating automatic tuning.

Furthermore, in this configuration, the first coefficient and the second coefficient constitute a single parameter, and the fourth coefficient and the fifth coefficient constitute a single parameter. Therefore, only four parameters need to be adjusted. Accordingly, compared to a configuration that requires six parameters, the adjustment is simpler, and the memory capacity can also be reduced.

In addition, among the four parameters, the first coefficient and the fourth coefficient can be automatically tuned using a pole-zero cancellation method. As a result, the number of parameters requiring manual adjustment can effectively be reduced to two: the third coefficient and the sixth coefficient.

Moreover, by determining the sixth coefficient relative to the third coefficient as a reference, the bandwidth of the minor loop can be made faster than the overall response characteristic. This allows the number of tuning parameters to be reduced to one while ensuring system stability.

In one embodiment, the sixth coefficient may be N times the third coefficient where N may a configurable real number greater than 1.

In one embodiment, a transfer function of a controlled plant having the current as an input and the rotational speed as an output may be expressed as 1/(τ_{M}·s+1), where τ_{M0} is a reference value of τ_{M}. The first coefficient may be represented by (1/τM0)×α. The first auto-tuning circuit may be configured to vary a with reference to 1.

In one embodiment, a transfer function of a controlled plant having a voltage applied to the motor as an input and a current as an output may be expressed as 1/(τ_{C}·s+1), where τ_{C0} is a reference value of τ_{C}. The fourth coefficient is represented by (1/τ_{C0})×β. The second auto-tuning circuit may be configured to vary β with reference to 1.

### Embodiments

Embodiments of the present disclosure will be described more fully hereinafter with reference to the accompanying drawings in which like numerals represent like elements throughout the several figures, and in which example embodiments are shown. Embodiments of the claims may, however, be embodied in many different forms and should not be construed as limited to the embodiments set forth herein. The examples set forth herein are non-limiting examples and are merely examples among other possible examples.

In this specification, a phrase such as “member A is in a state of being connected to member B” includes cases where A and B are physically directly connected, and cases where they are indirectly connected via other members without affecting their connectivity or the functions or effects produced by their connection.

Similarly, a phrase such as “member C is provided between member A and member B” includes cases where C is directly connected to A or B, and cases where C is indirectly connected via other members without affecting electrical connections or the functions or effects produced.

In general, a controlled plant is modeled as a first-order lag element, and a PI (Proportional-Integral) compensator is used as a controller. The coefficients of the PI compensator are set such that the input-output characteristic of the system becomes equivalent to that of a simple first-order low-pass filter. Methods for setting the coefficients include, for example, a pole-zero cancellation method.

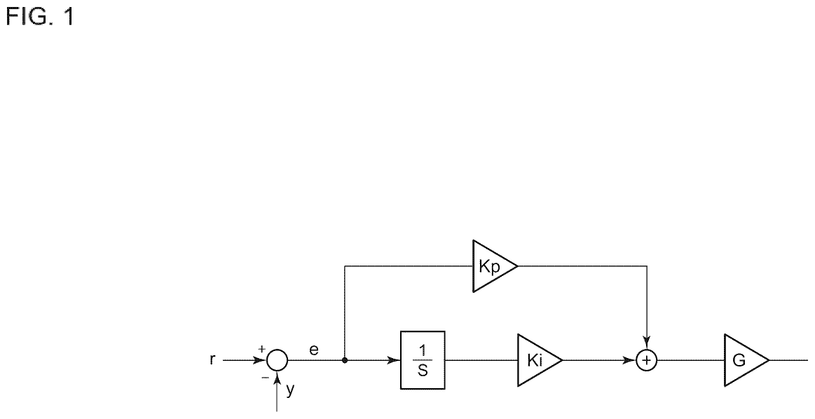

FIG. 1 is a block diagram of a typical PI (Proportional-Integral) compensator used for motor control. This compensator includes three parameters: specifically, a proportional gain Kp, an integral gain Ki, and a gain G of a low-pass filter.

When this PI compensator is applied to a multi-loop system having one major loop and one minor loop, six parameters are present. Therefore, memory is required to store all six parameters. In addition, since all of the parameters must be adjusted independently, there is a problem in that the adjustment process becomes complicated.

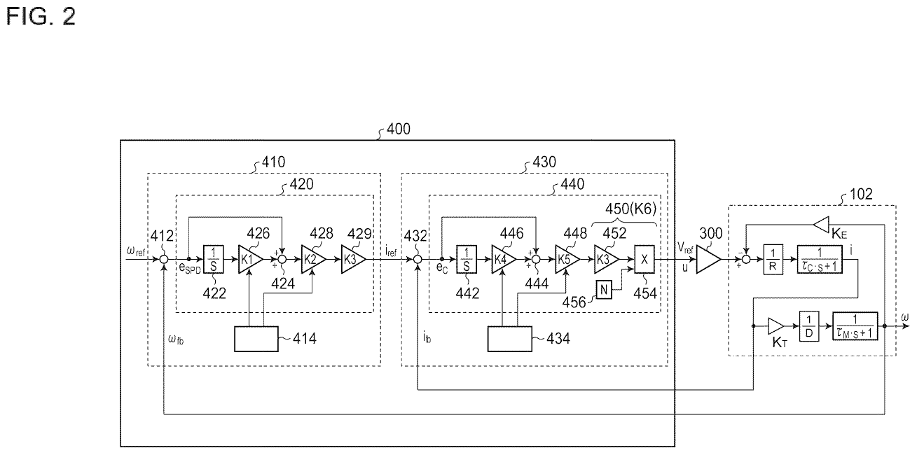

FIG. 2 is a block diagram of a motor drive system 100 including a controller circuit 400 according to an embodiment. The motor drive system 100 includes a motor 102, the controller circuit 400, and a drive circuit 300.

The motor 102 is, for example, a three-phase or single-phase brushless DC motor.

The controller circuit 400 performs feedback control on an electrical signal (power, voltage, or current) supplied to the motor 102 so that the motor 102 rotates at a target rotational speed ω_{ref}.

The controller circuit 400 may be implemented by a microcontroller (processor) in combination with a software program, by hardware logic such as a field programmable gate array (FPGA), or as an application specific integrated circuit (ASIC).

The drive circuit 300 supplies an electrical signal corresponding to the manipulated variable u generated by the controller circuit 400 to the motor 102. In the present embodiment, the manipulated variable u is a voltage command, and the drive circuit 300 supplies a drive voltage V_{DRV} based on the manipulated variable u to the motor 102.

The controller circuit 400 and the drive circuit 300 may be provided as separate integrated circuits (ICs), or may be integrated on a single semiconductor substrate as one IC.

The configuration of the controller circuit 400 will be described. The controller circuit 400 employs a multi-loop system including a major controller 410 and a minor controller 430.

The major controller 410 controls a major loop (outer loop) that uses a rotational speed ω of the motor 102 as a controlled variable. The major controller 410 generates a manipulated variable i_{ref} (current command) so that the error e_{SPD} between the detected rotational speed ω_{fb} of the motor 102 and the rotational speed command ω_{ref} approaches zero. The current command i_{ref} is supplied to the minor controller 430.

The minor controller 430 controls a minor loop (inner loop) that uses a current i flowing through the motor 102 as a controlled variable. The minor controller 430 generates a voltage command V_{ref} such that the error between the detected current i_{FB} of the motor 102 and the current command i_{ref} approaches zero. The voltage command V_{ref} corresponds to the manipulated variable u supplied to the drive circuit 300.

The major controller 410 includes a first error detector 412, a first PI compensator 420, and a first auto-tuning circuit 414. The first error detector 412 is a subtractor that generates a speed error e_{SPD} representing a difference between a detected rotational speed ω_{fb} of the motor 102 and a rotational speed command ω_{ref}. The first PI compensator 420 generates a current command i_{ref} such that the speed error e_{SPD} approaches zero. The first PI compensator 420 includes a first integrator 422, a first adder 424, a first coefficient circuit 426, a second coefficient circuit 428, and a third coefficient circuit 429.

The first integrator 422 integrates the speed error e_{SPD}. The first coefficient circuit 426 multiplies the output of the first integrator 422 by a first coefficient K1.

The first adder 424 adds the output of the first coefficient circuit 426 and the speed error e_{SPD}. The second coefficient circuit 428 multiplies the output of the first adder 424 by a second coefficient K2. The second coefficient K2 is an inverse of the first coefficient K1.

The third coefficient circuit 429 multiplies the output of the second coefficient circuit 428 by a third coefficient K3. The output of the third coefficient circuit 429 constitutes the current command i_{ref}.

The first auto-tuning circuit 414 adjusts the first coefficient K1 so that the phase difference between the speed error e_{SPD} and the rotational speed w, which serves as the controlled variable, becomes 90 degrees. When the first coefficient K1 is adjusted, the value of the second coefficient circuit 428, which is the inverse of K1, is also determined.

The minor controller 430 includes a second error detector 432, a second PI compensator 440, and a second auto-tuning circuit 434. The second error detector 432 is a subtractor that generates a current error e_{C} representing the difference between the detected current i_{FB} of the motor 102 and the current command i_{ref}. The second PI compensator 440 generates a voltage command V_{ref} such that the current error e_{C} approaches zero. The second PI compensator 440 includes a second integrator 442, a third adder 444, a fourth coefficient circuit 446, a fifth coefficient circuit 448, and a sixth coefficient circuit 450.

The second integrator 442 integrates the current error e_{C}. The fourth coefficient circuit 446 multiplies the output of the second integrator 442 by a fourth coefficient K4.

The third adder 444 adds the output of the fourth coefficient circuit 446 and the current error e_{C}. The fifth coefficient circuit 448 multiplies the output of the third adder 444 by a fifth coefficient K5. The fifth coefficient K5 is the inverse of the fourth coefficient K4.

The sixth coefficient circuit 450 multiplies the output of the fifth coefficient circuit 448 by a sixth coefficient K6. The output of the sixth coefficient circuit 450 constitutes the voltage command V_{ref}. The sixth coefficient K6 is defined relative to the third coefficient K3 used in the first PI compensator 420. Specifically, the value of the sixth coefficient K6 is N times the third coefficient K3. N is a real number greater than 1.

The sixth coefficient circuit 450 includes a coefficient circuit 452, a multiplier 454, and a constant circuit 456. The coefficient circuit 452 multiplies the output of the fifth coefficient circuit 448 by the third coefficient K3. The constant circuit 456 is a memory that stores a predetermined value N. The multiplier 454 multiplies the output of the coefficient circuit 452 by the predetermined value N.

The second auto-tuning circuit 434 adjusts the fourth coefficient K4 such that the phase difference between the current error e_{C} and the controlled variable current i becomes 90 degrees. When the fourth coefficient K4 is adjusted, the value of the fifth coefficient circuit 448, which is its inverse, is also determined.

The tuning performed by the first auto-tuning circuit 414 will be described.

For the motor 102, the transfer function having the coil current i as an input and the rotational speed ω as an output is represented by K_{T}/{D·(τ_{M}·s+1)}. K_{T} is a torque constant, and D is a viscous damping coefficient (viscous friction coefficient). The first auto-tuning circuit 414 performs auto-tuning based on a pole-zero cancellation method. When the phase difference between the speed error e_{SPD} and the rotational speed ω as the controlled variable becomes 90 degrees, the value of the first coefficient K1 becomes equal to τ_{M}.

Tuning by the second auto-tuning circuit 434 is similar. That is, for the motor 102, the transfer function having the drive voltage V_{DRV} as an input and the coil current i as an output is represented by 1/{R·(τ_{C}·s+1)}. By the auto-tuning performed by the second auto-tuning circuit 434, when the phase difference between the current error e_{C} and the current i as the controlled variable becomes 90 degrees, the value of the fourth coefficient K4 becomes equal to Tc. In FIG. 2, KE is a back electromotive force constant.

The foregoing constitutes the configuration of the controller circuit 400.

Next, tuning of the first PI compensator 420 of the major controller 410 will be described.

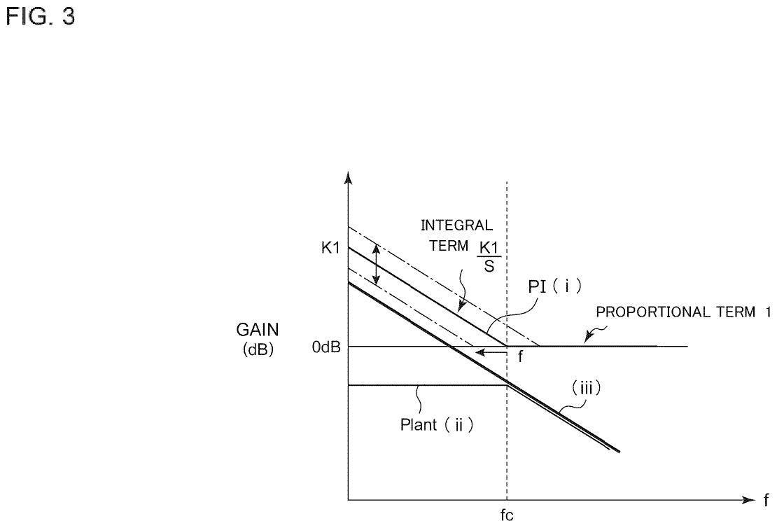

FIG. 3 is a diagram illustrating auto-tuning of the first coefficient K1 of the first PI compensator 420 of FIG. 2. In FIG. 3, (i) shows the gain characteristic of the portion that includes the integrator 422, the first coefficient circuit 426, and the first adder 424. The transfer function of this portion is (K1/s+1), where K1/s is the integral term and 1 is the proportional term. When the first coefficient K1 is varied, the integral term K1/s shifts upward or downward. In other words, the frequency f at which it intersects the 0 dB gain of the proportional term changes.

In FIG. 3, (ii) shows the gain characteristic of the controlled plant. The controlled plant is a first-order lag element having a transfer characteristic of 1/(τ_{M}·s+1), and thus exhibits the gain characteristic of a low-pass filter with a cutoff frequency fc corresponding to the time constant τ_{M}.

By tuning performed by the first auto-tuning circuit 414 using a pole-zero cancellation method, the first coefficient K1 is optimized so that the frequency f at which the integral term K1/s and the proportional term 1 intersect coincides with the cutoff frequency fc of the low-pass filter as the controlled plant.

When the first coefficient K1 is optimized, the gain characteristic of the overall system including the controlled plant and the first PI compensator 420 becomes the integral characteristic (iii).

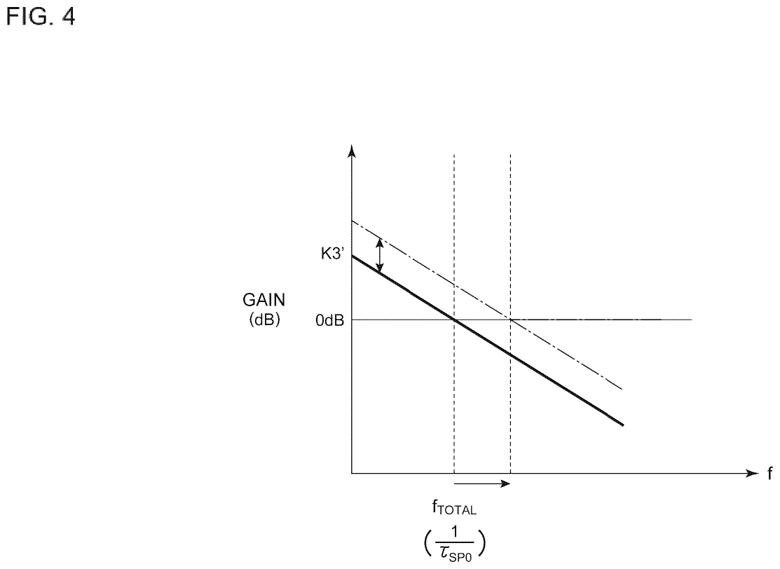

FIG. 4 is a diagram illustrating tuning of the third coefficient K3 of the first PI compensator 420 of FIG. 2. The first coefficient circuit 426 and the second coefficient circuit 428 cancel each other out. When the third coefficient K3 is varied, the gain characteristic of the overall system moves up or down while maintaining the integral characteristic. As a result, the cutoff frequency f_{TOTAL} (=1/τ_{SPD}) of the overall system's gain characteristic can be changed.

Next, tuning of the second PI compensator 440 of the minor controller 430 will be described. The fourth coefficient K4 and the fifth coefficient K5 are optimized by a pole-zero cancellation method in the same manner as the first coefficient K1 and the second coefficient K2 of the first PI compensator 420.

Moreover, the third coefficient K3 of the first PI compensator 420 has already been determined. The sixth coefficient K6 is N times the third coefficient K3. The third coefficient K3, as shown in FIG. 4, defines the cutoff frequency f (=1/τ_{SPD}) of the integration element in the major loop. Similarly, the sixth coefficient K6 defines the cutoff frequency of the integration element in the minor loop. Thus, the parameter N determines how much wider the bandwidth of the minor loop is relative to that of the major loop.

Furthermore, by setting N to a value greater than 1, the bandwidth ratio of the minor loop can be made larger than that of the overall response characteristic, thereby reducing the number of tuning parameters to one while ensuring system stability.

Next, the advantages of the controller circuit 400 will be described.

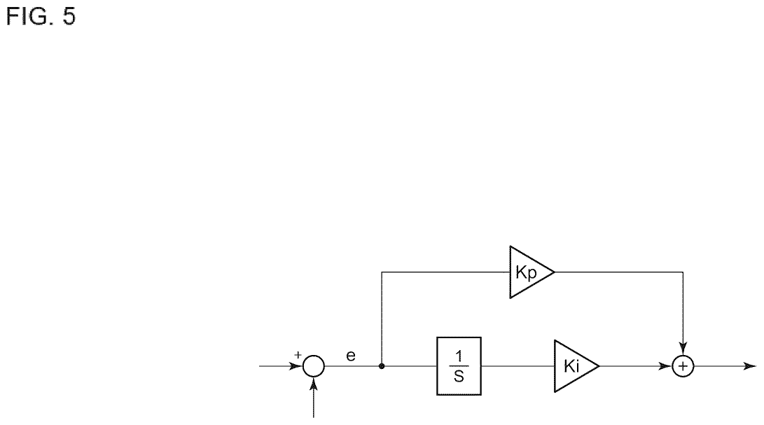

First advantage: FIG. 5 is a block diagram of a conventional PI compensator. In this configuration, changing the proportional gain Kp results in a change in the integral gain Ki that provides a 90-degree phase difference. Therefore, once the integral gain Ki is optimized to produce a 90-degree input-output phase difference and then the proportional gain Kp is changed, the overall frequency response deviates from that of the integrator, requiring readjustment of the integral gain Ki. In other words, it is difficult to optimize both parameters simultaneously.

By contrast, in the configuration of the first PI compensator 420 of FIG. 2, the second coefficient K2 and the third coefficient K3 do not affect the phase characteristic. Thus, after optimizing the first coefficient K1 so that the input-output phase difference is 90 degrees, varying the second coefficient K2 and the third coefficient K3 does not alter the overall integrator characteristic, eliminating the need to readjust the first coefficient K1

Similarly, for the second PI compensator 440, since varying the sixth coefficient K6 does not affect the integral characteristic of the overall system, there is no need to readjust the fourth coefficient K4.

In this configuration, the first coefficient K1 and the second coefficient K2 constitute a single parameter, and the fourth coefficient K4 and the fifth coefficient K5 constitute a single parameter. Therefore, only four parameters K1, K3, K4, and K6 need to be adjusted. Accordingly, compared to a conventional configuration requiring six parameters, adjustment is simplified, and memory capacity can also be reduced.

Furthermore, among the four parameters K1, K3, K4, and K6, since the first coefficient K1 and the fourth coefficient K4 can be automatically tuned by a pole-zero cancellation method, the configuration can effectively be simplified to two parameters: the third coefficient K3 and the sixth coefficient K6.

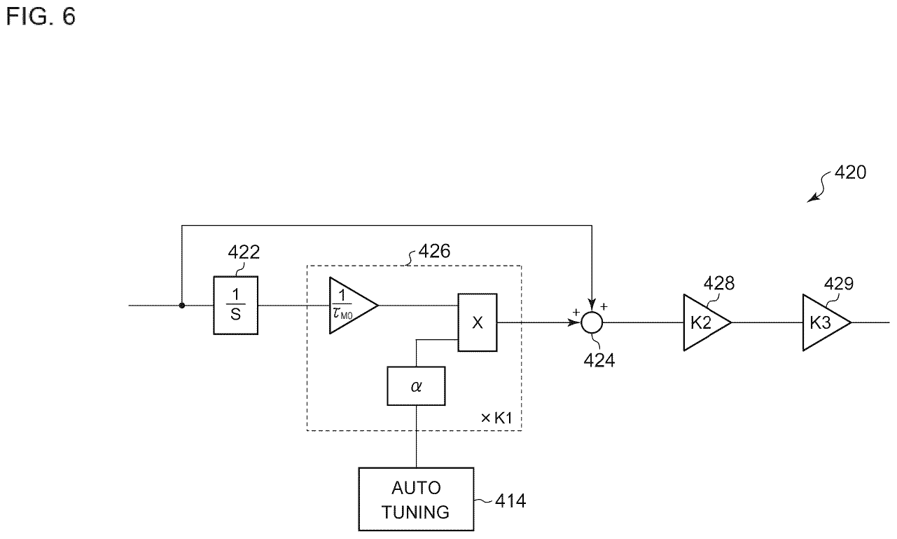

FIG. 6 is a block diagram of the first PI compensator 420 according to an embodiment. The controlled plant of the first PI compensator 420 is a first-order lag element, and its transfer function is represented by 1/(IM'S+1), where τ_{M} is a time constant.

In the first PI compensator 420 of FIG. 6, when the first coefficient K1 equals 1/τ_{M}, the phase difference between the input and output becomes 90 degrees. Here, a reference value τ_{M0} is defined for the time constant τ_{M} of the controlled plant. The reference value τ_{M0} may be set, for example, to the average of the time constants of several types of motors assumed as the controlled plant.

The first coefficient K1 of the first coefficient circuit 426 of the first PI compensator 420 is expressed as K1=(1/τ_{M0})×α. That is, the first coefficient K1 is obtained by multiplying the reference time constant τ_{M0} by a correction coefficient α. The first auto-tuning circuit 414 varies the correction coefficient α around 1 to adjust K1 such that the input-output phase difference becomes 90 degrees.

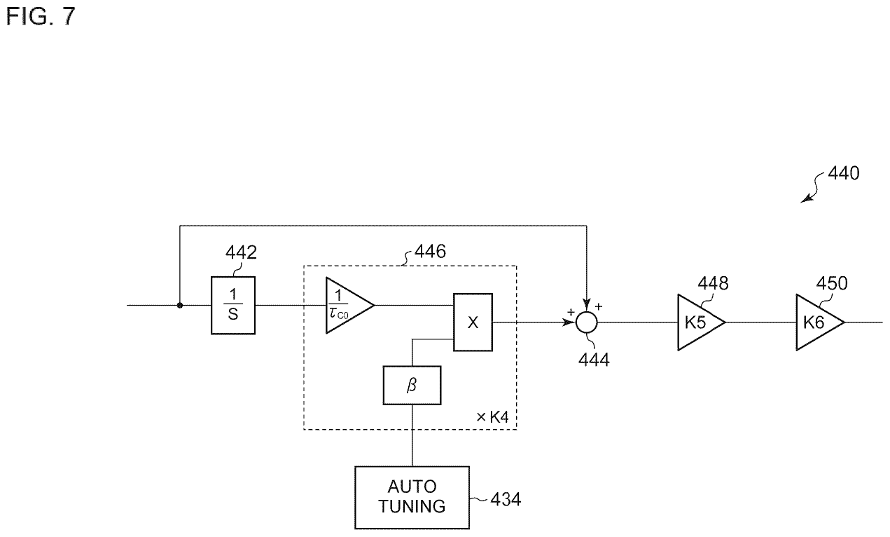

FIG. 7 is a block diagram illustrating a configuration example of the second PI compensator 440. The controlled plant of the second PI compensator 440 is a first-order lag element, and its transfer function is represented as 1/(τ_{C}·s+1), where Tc is a time constant.

In the second PI compensator 440 of FIG. 7, when the fourth coefficient K4 equals 1/τ_{C}, the phase difference between the input and output becomes 90 degrees. Here, a reference value τ_{C0} is defined for the time constant Tc of the controlled plant. The reference value τ_{C0} may be determined, for example, as the average of the time constants of several types of motors assumed as the controlled plant.

The fourth coefficient circuit 446 of the second PI compensator 440 has a fourth coefficient K4 expressed as K4=(1/τ_{C0})×β. That is, the fourth coefficient K4 is obtained by multiplying the reference time constant τ_{C0} by a correction coefficient β. The second auto-tuning circuit 434 varies the correction coefficient β around 1 to adjust K4 so that the input-output phase difference becomes 90 degrees.

The embodiments are presented by way of example, and it will be understood by those skilled in the art that various modifications may be made to the combinations of the constituent elements and processing steps. Such modifications are also included within the scope of the present disclosure or the present invention.

### Additional Note

The technology disclosed in the present specification can be understood, in one aspect, as described below.

### Item 1:

A controller circuit for a motor, comprising:
a major controller configured to control a rotational speed of the motor as a controlled variable; and
a minor controller provided inside the major controller and configured to control a current flowing through the motor as a controlled variable,
wherein the major controller includes:
a first Proportional-Integral (PI) compensator configured to generate a manipulated variable based on an error between a detected value of the controlled variable of the motor and a command value of the controlled variable; and
a first auto-tuning circuit configured to optimize parameters of the first PI compensator,
wherein the first PI compensator includes:
a first integrator configured to integrate the error;
a first gain circuit configured to multiply an output of the first integrator by a first coefficient;
a first adder configured to add the output of the first gain circuit and the error;
a second gain circuit configured to multiply an output of the first adder by a second coefficient, the second coefficient being an inverse of the first coefficient; and
a third gain circuit configured to multiply an output of the second gain circuit by a third coefficient,
the first auto-tuning circuit is configured to vary the first coefficient and to adjust the first coefficient to a value at which a phase difference between the error and the controlled variable becomes 90 degrees,
wherein the minor controller includes:
a second PI (Proportional-Integral) compensator configured to generate a manipulated variable based on an error between a detected value of the current of the motor and a current command value output from the first PI compensator; and
a second auto-tuning circuit configured to optimize parameters of the second PI compensator,
the second PI compensator includes:
a second integrator configured to integrate the error;
a fourth gain circuit configured to multiply an output of the second integrator by a fourth coefficient;
a second adder configured to add the output of the fourth gain circuit and the error;
a fifth gain circuit configured to multiply an output of the second adder by a fifth coefficient, the fifth coefficient being an inverse of the fourth coefficient; and
a sixth gain circuit configured to multiply an output of the fifth gain circuit by a sixth coefficient,
the second auto-tuning circuit is configured to vary the fourth coefficient and to adjust the fourth coefficient to a value at which a phase difference between the error and the controlled variable becomes 90 degrees,
and wherein the sixth coefficient is determined relative to the third coefficient as a reference.

### Item 2:

The controller circuit according to Item 1, wherein the sixth coefficient is N times the third coefficient, and wherein Nis a configurable real number greater than 1.

### Item 3:

The controller circuit according to Item 1 or 2, wherein a transfer function of a controlled plant having the current as an input and the rotational speed as an output is expressed as 1/(τ_{M}·s+1), wherein the first coefficient is represented by (1/τ_{M0})×α, where τ_{M0} is a reference value of τ_{M}, and wherein the first auto-tuning circuit is configured to vary a with reference to 1.

### Item 4:

The controller circuit according to Item 1 or 2, wherein a transfer function of a controlled plant having a voltage applied to the motor as an input and a current as an output is expressed as 1/(τ_{C}·s+1),
wherein the fourth coefficient is represented by (1/τ_{C0})×β, where τ_{C0} is a reference value of τ_{C},
and wherein the second auto-tuning circuit is configured to vary β with reference to 1.

What is claimed is:

1. A controller circuit for a motor, comprising:
a major controller configured to control a rotational speed of the motor as a controlled variable; and
a minor controller provided inside the major controller and configured to control a current flowing through the motor as a controlled variable,
wherein the major controller includes:
a first Proportional-Integral (PI) compensator configured to generate a manipulated variable based on an error between a detected value of the controlled variable of the motor and a command value of the controlled variable; and
a first auto-tuning circuit configured to optimize parameters of the first PI compensator,
wherein the first PI compensator includes:
a first integrator configured to integrate the error;
a first gain circuit configured to multiply an output of the first integrator by a first coefficient;
a first adder configured to add the output of the first gain circuit and the error;
a second gain circuit configured to multiply an output of the first adder by a second coefficient, the second coefficient being an inverse of the first coefficient; and
a third gain circuit configured to multiply an output of the second gain circuit by a third coefficient,
the first auto-tuning circuit is configured to vary the first coefficient and to adjust the first coefficient to a value at which a phase difference between the error and the controlled variable becomes 90 degrees,
wherein the minor controller includes:
a second PI (Proportional-Integral) compensator configured to generate a manipulated variable based on an error between a detected value of the current of the motor and a current command value output from the first PI compensator; and
a second auto-tuning circuit configured to optimize parameters of the second PI compensator,
the second PI compensator includes:
a second integrator configured to integrate the error;
a fourth gain circuit configured to multiply an output of the second integrator by a fourth coefficient;
a second adder configured to add the output of the fourth gain circuit and the error;
a fifth gain circuit configured to multiply an output of the second adder by a fifth coefficient, the fifth coefficient being an inverse of the fourth coefficient; and
a sixth gain circuit configured to multiply an output of the fifth gain circuit by a sixth coefficient,
the second auto-tuning circuit is configured to vary the fourth coefficient and to adjust the fourth coefficient to a value at which a phase difference between the error and the controlled variable becomes 90 degrees,
and wherein the sixth coefficient is determined relative to the third coefficient as a reference.

2. The controller circuit according to claim 1, wherein the sixth coefficient is N times the third coefficient, and wherein N is a configurable real number greater than 1.

3. The controller circuit according to claim 1, wherein a transfer function of a controlled plant having the current as an input and the rotational speed as an output is expressed as 1/(τ_{M}·s+1),
wherein the first coefficient is represented by (1/τM0)×α, where τ_{M0} is a reference value of τ_{M},
and wherein the first auto-tuning circuit is configured to vary α with reference to 1.

4. The controller circuit according to claim 1, wherein a transfer function of a controlled plant having a voltage applied to the motor as an input and a current as an output is expressed as 1/(τ_{C}·s+1),
wherein the fourth coefficient is represented by (1/τ_{C0})×β, where τ_{C0} is a reference value of τ_{C},
and wherein the second auto-tuning circuit is configured to vary β with reference to 1.
